(19) United States
(12) Patent Application Publication
(10) Pub. No.: US 2025/0186957 A1
(43) Pub. Date: Jun. 12, 2025

(54) DECOMPOSING A FEEDSTOCK USING A ROTATING DETONATION ENGINE

(71) Applicant: EKONA POWER INC., Burnaby (CA)

(72) Inventors: Donald W. KENDRICK, Bellevue, WA (US); Eric A. WHEELER, Abilene, TX (US); Scott Cameron GRAY, Ottawa (CA)

(21) Appl. No.: 18/975,475

(22) Filed: Dec. 10, 2024

Related U.S. Application Data
(60) Provisional application No. 63/609,222, filed on Dec. 12, 2023.

(51) Int. Cl. B01J 6/00; B09B 3/40; F01D 25/00

(52) U.S. Cl. CPC B01J 6/008; B09B 3/40; F01D 25/005

(57) ABSTRACT

A mixture of a fuel and an oxidant is flowed into a rotating detonation engine defining a longitudinal axis and having an outer body and an inner body spaced from the outer body to thereby define an annular combustion chamber. The fuel is combusted in the presence of the oxidant in the annular combustion chamber so as to generate a detonation wave that rotates in the combustion chamber around the longitudinal axis and produces one or more combustion products that flow out of the rotating detonation engine. The one or more combustion products are mixed with a feedstock so as to decompose the feedstock.

### CROSS-REFERENCE TO RELATED APPLICATION

This application claims priority from U.S. Provisional Patent Application Ser. No.: 63/609,222 filed on Dec. 12, 2023, the entire disclosures of which are part of the disclosure of the present application and are hereby incorporated by reference in their entireties.

### FIELD

The present disclosure relates to thermal pyrolysis and in particular to methods and systems for decomposing a feedstock using a rotating detonation engine.

### BACKGROUND

Thermal pyrolysis is a method by which a feedstock gas, such as a hydrocarbon, is decomposed without oxygen into its constituent elements (in the case of a hydrocarbon, carbon and hydrogen). The decomposition is triggered by sufficiently raising the temperature of the feedstock gas to a point at which the chemical bonds of the elements of the feedstock gas break down.

Pyrolysis may be achieved by bringing the feedstock gas into thermal contact with a hot fluid. In one example, combustion product gases, formed as a result of combusting a combustible fuel, may be mixed with the feedstock gas. At high-enough temperatures, the mixing of the hot fluid with the feedstock gas, and the transfer of thermal energy from the hot fluid to the feedstock gas, is sufficient to cause the feedstock gas to break down and decompose.

One type of reactor that may be used to decompose a feedstock is a constant-volume feedstock reactor which is designed for repeated, cyclic use. Each reaction cycle, valves are opened to allow the feedstock and a combustible gas mixture to enter their respective chambers. The valves are then closed, the combustible mixture is combusted and mixed with the feedstock to trigger pyrolysis, and the valves are then re-opened to extract the reaction products. Because of the substantially sealed nature of the reaction and combustion chambers during the combustion and reaction phases, it is easier to achieve the relatively high temperatures and pressures needed for pyrolysis to occur.

However, in such a reactor, proper operation of the valves can be difficult and complex. For example, the timing of the valve activations must by tightly controlled, the valves need to operate at high speeds, and valve leakages can occur. Such leakage may result in cross-contamination of the gases and may reduce the efficiency of the pyrolysis. In addition, the cyclic nature of the reactor's operation can have adverse effects on downstream componentry, and subjects the reactor's refractory ceramics to repeated thermal shock. Further still, additional modules (such as purge/surge vessels and accumulators) may be require to dampen pressure and harmonic oscillations associated with rapid opening/closing of the valves.

### SUMMARY

According to a first aspect of the disclosure, there is provided a method of decomposing a feedstock, comprising: flowing a mixture of a fuel and an oxidant into a rotating detonation engine defining a longitudinal axis and comprising an outer body and an inner body spaced from the outer body to thereby define an annular combustion chamber; combusting the fuel in the presence of the oxidant in the annular combustion chamber so as to generate a detonation wave that rotates in the combustion chamber around the longitudinal axis and produces one or more combustion products that flow out of the rotating detonation engine; and mixing the one or more combustion products with a feedstock so as to decompose the feedstock.

Flowing the mixture of the fuel and the oxidant into the rotating detonation engine may comprise flowing the fuel into the annular combustion chamber in a direction parallel to the longitudinal axis.

Flowing the mixture of the fuel and the oxidant into the rotating detonation engine may comprise flowing the oxidant into the annular combustion chamber in a direction oblique to the longitudinal axis.

Flowing the oxidant into the annular combustion chamber in the direction oblique to the longitudinal axis may comprise flowing the oxidant into the annular combustion chamber in a direction perpendicular to the longitudinal axis.

Mixing the one or more combustion products with the feedstock may comprise: flowing the feedstock through a hollow interior of the inner body; and mixing the one or more combustion products with the feedstock that has flowed through the hollow interior of the inner body.

Mixing the one or more combustion products with the feedstock may comprise introducing bulk axial vorticity to one or both of: the feedstock that has flowed through the hollow interior of the inner body; and the one or more combustion products.

Mixing the one or more combustion products with the feedstock may comprise imparting streamwise vorticity to one or both of: the feedstock that has flowed through the hollow interior of the inner body; and the one or more combustion products.

The fuel and the feedstock may have the same composition. The fuel and the feedstock may have different compositions.

According to a further aspect of the disclosure, there is provided a feedstock reactor comprising: a rotating detonation engine defining a longitudinal axis and comprising: an outer body; and an inner body spaced from the outer body and thereby defining an annular combustion chamber; one or more first fluid passages for flowing a mixture of a fuel and an oxidant to the annular combustion chamber; an igniter for triggering, in the annular combustion chamber, combustion of the fuel in the presence of the oxidant, a reaction chamber connected to an output of the rotating detonation engine; and one or more second fluid passages for flowing a feedstock into the reaction chamber, wherein, in response to combustion of the fuel in the annular combustion chamber, a detonation wave is generated and rotates in the combustion chamber around the longitudinal axis, thereby producing one or more combustion products that flow out of the rotating detonation engine, into the reaction chamber, mix with the feedstock, and decompose the feedstock.

The one or more first fluid passages may comprise one or more fluid passages extending in a direction parallel to the longitudinal axis and for flowing the fuel into the annular combustion chamber.

The one or more second fluid passages may comprise a hollow portion extending through the inner body for allowing the feedstock to flow through the rotating detonation engine and into the reaction chamber.

The feedstock reactor may further comprise a lobe mixer downstream of the rotating detonation engine and for introducing bulk axial vorticity to one or both of: the feedstock that has flowed through the hollow interior of the inner body; and the one or more combustion products.

The lobe mixer may comprise one or more surface features thereon for imparting streamwise vorticity to one or both of: the feedstock that has flowed through the hollow interior of the inner body; and the one or more combustion products.

At least one of the one or more first fluid passages may extend in a direction parallel to the longitudinal axis.

At least one of the one or more first fluid passages may extend in a direction oblique to the longitudinal axis.

At least one of the one or more first fluid passages may extend in a direction parallel to the longitudinal axis, and at least another one of the one or more first fluid passages may extend in a direction perpendicular to the longitudinal axis.

This summary does not necessarily describe the entire scope of all aspects. Other aspects, features and advantages will be apparent to those of ordinary skill in the art upon review of the following description of specific embodiments.

### DRAWINGS

Embodiments of the disclosure will now be described in detail in conjunction with the accompanying drawings of which:

FIG. 1A is a schematic diagram of a rotating detonation engine according to an embodiment of the disclosure;

FIG. 1B shows a detonation wave rotating in the combustion chamber of a rotating detonation engine, according to embodiments of the disclosure;

FIG. 2 is a schematic diagram of a steady-state feedstock reactor incorporating a rotating detonation engine, according to an embodiment of the disclosure; and

FIG. 3 is a schematic diagram of a method of decomposing a feedstock using a rotating detonation engine, according to an embodiment of the disclosure.

### DETAILED DESCRIPTION

The present disclosure seeks to provide a novel methods and systems for decomposing a feedstock using a rotating detonation engine. While various embodiments of the disclosure are described below, the disclosure is not limited to these embodiments, and variations of these embodiments may well fall within the scope of the disclosure which is to be limited only by the appended claims.

Generally, according to embodiments of the disclosure, a fuel and an oxidant are flowed into a rotating detonation engine defining a longitudinal axis. The rotating detonation engine comprises an outer body and an inner body spaced from the outer body to thereby define an annular combustion chamber. The fuel is combusted in the presence of the oxidant and in the annular combustion chamber so as to generate a detonation wave that rotates in the combustion chamber around the longitudinal axis and that produces one or more combustion products that flow out of the rotating detonation engine. The one or more combustion products mix with a feedstock so as to decompose the feedstock.

Further embodiments of the disclosure employ a rotating detonation engine (RDE) integrated into a feedstock reactor to allow for a process wherein the products of a detonation combustion within the RDE are fed directly into a downstream reaction chamber in a steady, continuous manner. According to some embodiments, an RDE is an engine that uses a form of pressure gain combustion and in which one or more detonations continuously travel around an annular channel (the “combustion chamber”). Because of the relatively confined combustion chamber defined by the inner and outer bodies of the RDE, the RDE may leverage the relatively high temperatures and pressures generated by combustion in such a confined chamber, but without being restricted to a constant-volume environment. Fuel and an oxidant are added to the annular combustion chamber and then mixed and ignited by the rapidly circling detonation wave. There may be more than one detonation wave simultaneously circling within the combustion chamber. The result is an engine that produces continuous thrust, rather than thrust in pulses, while still offering the improved efficiency of a detonation engine.

Therefore, rather than using a cyclical, fixed-volume process in which the reactor is cyclically loaded with feedstock and a combustible gas mixture, and then purged following pyrolysis, a constant, steady stream of feedstock and combustible gas may be fed through the RDE, and the output of the RDE may be connected to a reaction chamber in which the pyrolysis occurs. Generally, in a steady-state process, the temperatures and pressures that are achieved during combustion are lower than in a constant-volume process. However, in the present case, the use of the RDE may still enable relatively higher temperatures and pressures to be achieved because of the confined nature of the combustion chamber. Therefore, the use of the RDE leverages the benefits of constant-volume combustion in a steady-state environment to exploit the benefits of both.

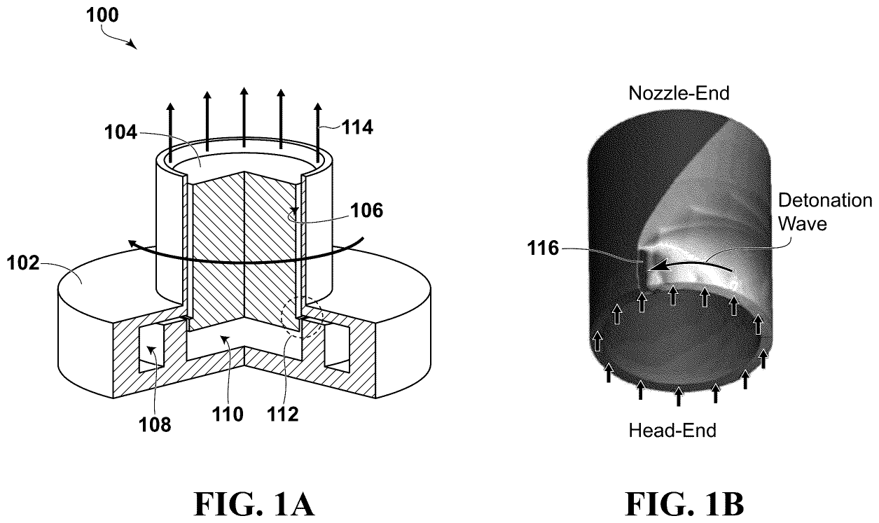

Turning to FIG. 1A, there is shown an example RDE 100 according to an embodiment of the disclosure. RDE 100 comprises an outer body 102 spaced from an inner body 104. The spacing defines a narrow, annular combustion chamber 106 between outer body 102 and inner body 104. An oxidant (e.g., air or pure oxygen) may be delivered via a suitable fluid passageway 108 to a first end of combustion chamber 106, and a fuel (e.g., methane or natural gas) may be delivered via a suitable fluid passageway 110 to the same end of combustion chamber 106. The oxidant and the fuel, upon arriving in combustion chamber 106, may mix in a mixing zone 112. In the example shown in FIG. 1A, the oxidant is delivered into combustion chamber 106 in a direction that is perpendicular to the longitudinal axis of RDE 100, whereas the fuel is delivered into combustion chamber 106 in a direction that is aligned with the longitudinal axis of RDE 100. While this may improve the mixing of the fuel and oxidant, any other suitable delivery mode or direction is envisioned. According to other embodiments, the fuel and the oxidant may be premixed before entering RDE 100, and the premix may be delivered directly to combustion chamber 106.

One or more igniters (not shown) within combustion chamber 106 trigger the combustion of the fuel, resulting in a rotating detonation wave that rotates within combustion chamber 106 and about a longitudinal axis defined by RDE 100. The detonation wave generates combustion products 114 that are ejected from the opposite end of RDE 100. According to some embodiments, it is conceivable that the fuel may be pre-heated prior to being delivered to combustion chamber 106, and may spontaneously combust in response to mixing with the oxidant when the oxidant is also delivered to combustion chamber 106.

An example of a detonation wave 116 can be seen in FIG. 1B. In detonative combustion, the combustion products expand at supersonic speed. It is theoretically more efficient than conventional deflagrative combustion, by as much as 25%. The size of the annulus defined by combustion chamber 106 should be sufficiently small to sustain a detonation wave. According to some embodiments, the size of the annulus is about 3-5 times the size of an average size of a detonation cell, wherein a detonation cell is a discrete unit or region where the combustion process occurs within the detonation wave. The structure of the detonation wave is often organized into individual cells, each representing a localized combustion event. According to some embodiments, the pressure generated within combustion chamber 106 may be at least 400 bar. Furthermore, the rotation of the detonation wave produces an axial force that may assist in drawing further fuel and oxidant into combustion chamber 106, thereby sustaining the combustion within combustion chamber 106.

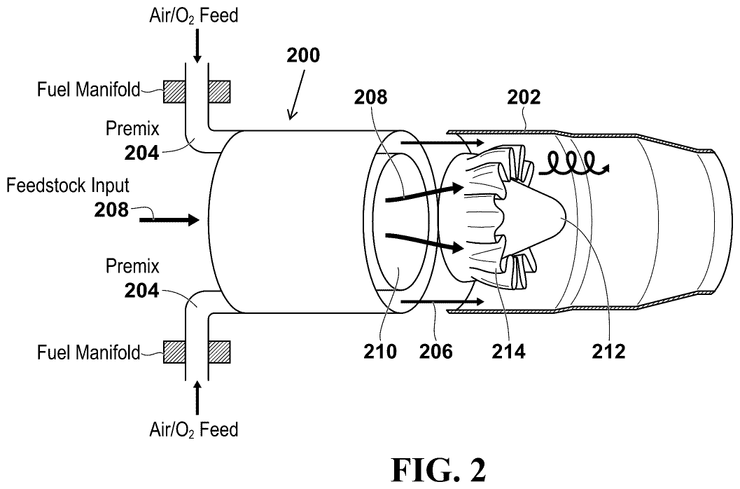

Turning to FIG. 2, there is shown an RDE 200 with its output coupled to a reaction chamber 202. In the embodiment shown in FIG. 2, a premix 204 of fuel and oxidant is delivered to the combustion chamber of RDE 200, as described above. Premix 204 is combusted in the combustion chamber, and one or more rotating detonative waves are thereby produced in the combustion chamber, resulting in hot combustion products 206 that are ejected from the combustion chamber at the distal end of RDE 200. Meanwhile, a feedstock 208 (such as a hydrocarbon, for example methane) is flowed through the interior of RDE 200 and into reaction chamber 202. In this example, the interior 210 of the inner body of RDE 200 is hollow to permit feedstock 208 to flow through RDE 200, but in other embodiments feedstock 208 may be delivered to reaction chamber 202 via some other means (in such a case, interior 210 of RDE 200 does not need to be hollow). Feedstock 208 may be pre-heated to lower the thermal energy requirements of the pyrolysis.

A mixer 212 such as a lobe mixer may be located at the output of RDE 200 and is configured to promote mixing between the hot combustion products 206 output by RDE 200 and feedstock 208 flowing into reaction chamber 202. In particular, according to some embodiments, bulk axial vorticity may be imparted by mixer 212 to feedstock 208 that has flowed through hollow interior 210 of RDE 200, and to combustion products 206. According to some embodiments, features 214 may be provided on mixer 212 in order to induce streamwise vorticity to feedstock 208 that has flowed through hollow interior 210 of RDE 200, and to combustion products 206, thereby creating secondary motion and hence a thorough mixing of feedstock 208 and combustion products 206. While only one mixing scheme has been shown, it should be noted that many mixing schemes between the two gases are envisioned.

During pyrolysis, thermal energy is transferred from combustion products 206 to feedstock 208. Past a certain point, the increase in the temperature of feedstock 208 is sufficient to drive decomposition or pyrolysis of feedstock 208. In the case of methane, for example, the decomposition takes the following form:

CH₄+energy→C+2H₂

The pyrolysis reaction generates reaction products which, in the case of methane pyrolysis, comprise one or more of hydrogen, nitrogen, and carbon. The net effect is a continuous feed of pyrolysis products to downstream componentry which may not be accustomed to cyclic fluid feeds.

Alternatively, RDE 200 may be closely coupled to a nozzle arrangement configured to inject the hot products of combustion into the reaction chamber, thereby resulting in mixing between the hot combustion products and the feedstock and initiating the pyrolysis reaction.

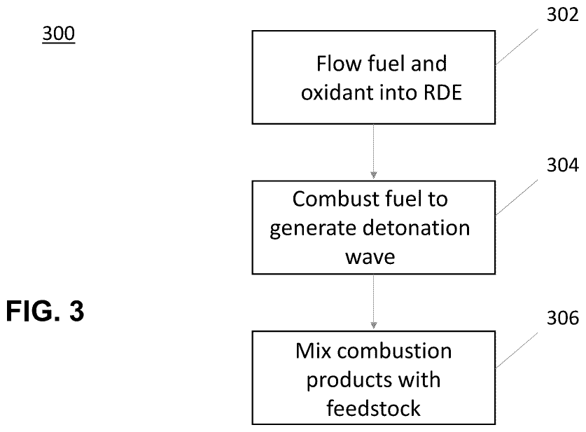

Turning to FIG. 3, there is shown a schematic diagram of a method of decomposing a feedstock using a rotating detonation engine, according to an embodiment of the disclosure.

At block 302, a fuel and an oxidant are flowed into the combustion chamber of the RDE.

At block 304, the fuel is combusted and a detonation wave is generated that produces combustion products that are then expelled from the outlet of the RDE.

At block 306, the combustion products expelled from the RDE mix with a feedstock to drive decomposition of the feedstock by pyrolysis.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A method of decomposing a feedstock, comprising:
flowing a mixture of a fuel and an oxidant into a rotating detonation engine defining a longitudinal axis and comprising an outer body and an inner body spaced from the outer body to thereby define an annular combustion chamber;
combusting the fuel in the presence of the oxidant in the annular combustion chamber so as to generate a detonation wave that rotates in the combustion chamber around the longitudinal axis and produces one or more combustion products that flow out of the rotating detonation engine; and
mixing the one or more combustion products with a feedstock so as to decompose the feedstock.

2. The method of claim 1, wherein flowing the mixture of the fuel and the oxidant into the rotating detonation engine comprises flowing the fuel into the annular combustion chamber in a direction parallel to the longitudinal axis.

3. The method of claim 1, wherein flowing the mixture of the fuel and the oxidant into the rotating detonation engine comprises flowing the oxidant into the annular combustion chamber in a direction oblique to the longitudinal axis.

4. The method of claim 3, wherein flowing the oxidant into the annular combustion chamber in the direction oblique to the longitudinal axis comprises flowing the oxidant into the annular combustion chamber in a direction perpendicular to the longitudinal axis.

5. The method of claim 1, wherein mixing the one or more combustion products with the feedstock comprises:
flowing the feedstock through a hollow interior of the inner body; and
mixing the one or more combustion products with the feedstock that has flowed through the hollow interior of the inner body.

6. The method of claim 5, wherein mixing the one or more combustion products with the feedstock comprises introducing bulk axial vorticity to one or both of: the feedstock that has flowed through the hollow interior of the inner body; and the one or more combustion products.

7. The method of claim 5, wherein mixing the one or more combustion products with the feedstock comprises imparting streamwise vorticity to one or both of: the feedstock that has flowed through the hollow interior of the inner body; and the one or more combustion products.

8. The method of claim 1, wherein the fuel and the feedstock have the same composition.

9. The method of claim 1, wherein the fuel and the feedstock have different compositions.

10. A feedstock reactor comprising:
a rotating detonation engine defining a longitudinal axis and comprising:
an outer body; and
an inner body spaced from the outer body and thereby defining an annular combustion chamber;
one or more first fluid passages for flowing a mixture of a fuel and an oxidant to the annular combustion chamber;
an igniter for triggering, in the annular combustion chamber, combustion of the fuel in the presence of the oxidant,
a reaction chamber connected to an output of the rotating detonation engine; and
one or more second fluid passages for flowing a feedstock into the reaction chamber,
wherein, in response to combustion of the fuel in the annular combustion chamber, a detonation wave is generated and rotates in the combustion chamber around the longitudinal axis, thereby producing one or more combustion products that flow out of the rotating detonation engine, into the reaction chamber, mix with the feedstock, and decompose the feedstock.

11. The feedstock reactor of claim 10, wherein the one or more first fluid passages comprise one or more fluid passages extending in a direction parallel to the longitudinal axis and for flowing the fuel into the annular combustion chamber.

12. The feedstock reactor of claim 10, wherein the one or more second fluid passages comprise a hollow portion extending through the inner body for allowing the feedstock to flow through the rotating detonation engine and into the reaction chamber.

13. The feedstock reactor of claim 12, further comprising a lobe mixer downstream of the rotating detonation engine and for introducing bulk axial vorticity to one or both of: the feedstock that has flowed through the hollow interior of the inner body; and the one or more combustion products.

14. The feedstock reactor of claim 13, wherein the lobe mixer comprises one or more surface features thereon for imparting streamwise vorticity to one or both of: the feedstock that has flowed through the hollow interior of the inner body; and the one or more combustion products.

15. The feedstock reactor of claim 10, wherein at least one of the one or more first fluid passages extends in a direction parallel to the longitudinal axis.

16. The feedstock reactor of claim 10, wherein at least one of the one or more first fluid passages extends in a direction oblique to the longitudinal axis.

17. The feedstock reactor of claim 10, wherein:
at least one of the one or more first fluid passages extends in a direction parallel to the longitudinal axis; and
at least another one of the one or more first fluid passages extends in a direction perpendicular to the longitudinal axis.
